(19) United States
(12) Patent Application Publication
(10) Pub. No.: US 2026/0236860 A1
(43) Pub. Date: Aug. 13, 2026

(54) DEEP-LEARNING BASED PERSONA SPECIFIC INSIGHT GENERATOR

(71) Applicant: HITACHI VANTARA LLC, Santa Clara, CA (US)

(72) Inventors: Hareesh Kumar Reddy KOMMEPALLI, Clifton Park, NY (US); Wei LIN, Plainsboro, NJ (US)

(21) Appl. No.: 19/156,585

(22) PCT Filed: Feb. 28, 2023
(86) PCT No.: PCT/US2023/014187

§ 371 Date: Aug. 14, 2025

(51) Int. Cl. G06Q 10/0631; G06N 20/00

(52) U.S. Cl. CPC G06Q 10/063112; G06N 20/00

(57) ABSTRACT

A method for generating persona specific insights. The method may include receiving sensor data associated with a device; extracting features from the received sensor data; processing the features using a machine learning model to generate machine learning metrics; ingesting the machine learning metrics and the features to generate insights data associated with the device; generating personas data using the insights data and the features, and mapping the insights to the personas data; generating custom insights using the insights data, the personas data, and the features, wherein the custom insights are text-based summaries; and disseminating each of the custom insights to respective persona of the personas data to place service orders associated with the device.

### BACKGROUND

### Field

The present disclosure is generally directed to a method and a system for generating persona specific insights

### Related Art

Advancement in technology has led has to growing complexity in Internet of Things (IT) devices and inter-system/intra-system automation. In an industrial operation and maintenance setting, there are a number of personas like mechanical engineers, electrical engineers, maintenance engineers, civil engineers, field service technicians, chemical engineers, drilling engineers, industrial engineers, repair technicians, operations field technicians, controls engineers, etc., needed to perform proper upkeep/maintenance of devices/machineries.

Based on their academic training and work experience, such personas are typically trained with specific technologies/disciplines and the technical language associated with the technologies/disciplines. Additionally, same terminologies may carry different meanings across the different technologies/disciplines and personas. For example, the term “filter” may be understood by a water reliability engineer as a water filter, but could mean something completely different for a controls engineer, for example, the term “filter” may be understood as a prediction algorithm.

Furthermore, terminology can be very specific and precise according to engineering disciplines. For example, the word “control” is used to refer to a benchmark in the healthcare industry, while the same word is typically not used by a maintenance engineer. Besides language and terminology, insights based on same sensor signals need to be segregated based on persona.

With siloed tribal knowledge and attrition of experienced cross-domain workers due to retirement, there is an unmet need for a solution that bridges the diluted human capability of system comprehension.

### SUMMARY

Aspects of the present disclosure involve an innovative method for generating persona specific insights. The method may include receiving sensor data associated with a device; cleaning the received sensor data to generate cleansed data; processing the cleansed data using a machine learning model to generate machine learning metrics; ingesting the machine learning metrics to generate insights data associated with the device; generating personas data using the insights data, and mapping the insights to the personas data; generating custom insights using the insights data and the personas data, wherein the custom insights are text-based summaries; and disseminating each of the custom insights to respective persona of the personas data to place service orders associated with the device.

Aspects of the present disclosure involve an innovative non-transitory computer readable medium, storing instructions for generating persona specific insights. The instructions may include receiving sensor data associated with a device; cleaning the received sensor data to generate cleansed data; processing the cleansed data using a machine learning model to generate machine learning metrics; ingesting the machine learning metrics to generate insights data associated with the device; generating personas data using the insights data, and mapping the insights to the personas data; generating custom insights using the insights data and the personas data, wherein the custom insights are text-based summaries; and disseminating each of the custom insights to respective persona of the personas data to place service orders associated with the device.

Aspects of the present disclosure involve an innovative server system for generating persona specific insights. The server system may include receiving sensor data associated with a device; cleaning the received sensor data to generate cleansed data; processing the cleansed data using a machine learning model to generate machine learning metrics; ingesting the machine learning metrics to generate insights data associated with the device; generating personas data using the insights data, and mapping the insights to the personas data; generating custom insights using the insights data and the personas data, wherein the custom insights are text-based summaries; and disseminating each of the custom insights to respective persona of the personas data to place service orders associated with the device.

Aspects of the present disclosure involve an innovative system for generating persona specific insights. The system may include means for receiving sensor data associated with a device; means for cleaning the received sensor data to generate cleansed data; means for processing the cleansed data using a machine learning model to generate machine learning metrics; means for ingesting the machine learning metrics to generate insights data associated with the device; means for generating personas data using the insights data, and means for mapping the insights to the personas data; generating custom insights using the insights data and the personas data, wherein the custom insights are text-based summaries; and disseminating each of the custom insights to respective persona of the personas data to place service orders associated with the device.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates an example process flow for generating persona-based insights, in accordance with an example implementation.

FIG. 2 illustrates example process flows for machine learning model development and deployment/actual use, in accordance with an example implementation.

FIG. 3 illustrates example process flows for model development and deployment/actual use of the insights model, in accordance with an example implementation.

FIG. 4 illustrates example process flow for persona generation through a personas model, in accordance with an example implementation.

FIG. 5 illustrates an example process flow for transformer model/text generation model development and deployment, in accordance with an example implementation.

FIG. 6 illustrates an example process flow for generating personalized text through transformer models, in accordance with an example implementation.

FIG. 7 illustrates example outputs from the various models, in accordance with an example implementation.

FIG. 8 illustrates an example computing environment with an example computing device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination, and the functionality of the example implementations can be implemented through any means according to the desired implementations.

Example implementations described herein utilize machine learning/deep learning (autoencoder) as a translator trained by IoT sensor signals, system logs, maintenance notes, outage events, proscribed actions, and technical notes, with corresponding failure modes to facilitate different personas in play in performing system/device maintenance and upkeep. Such personas may include, but not limited to, electric technicians, mechanical technicians, maintenance managers, structure engineers, electrical engineers, mechanical engineering, sustainable engineering managers, operators, business owners, etc.

Example implementations decipher the IoT event digital signals and their equivalent system behaviors during the technical triages, and provide functional descriptions to the various personas. Given the complex persona in scope, the taxonomy complexity across disciplines for explaining the same set of digital signals/data need to be encapsulated within the intelligence system with proper interpretations of the same term. For example, the term “filter” in the digital signal processing space involves noise removal in digital signal, whereas the term “filter” in the fluid processing space involves contamination removal from liquid.

For the cross functional triage descriptions with many personas in scope, the goal is to converge personas' diagnostic conclusions and results to the same failure mode to be resolved. Example implementations treat each persona and persona taxonomy as a different taxonomy and language (e.g., English, Japanese, French, etc.) to corresponding common sensor data and events as training pairs. From which, the same batch of event signals would result. Additional ensemble models will take in the results and process if there is more than one failure mode reached for ranking and prioritization.

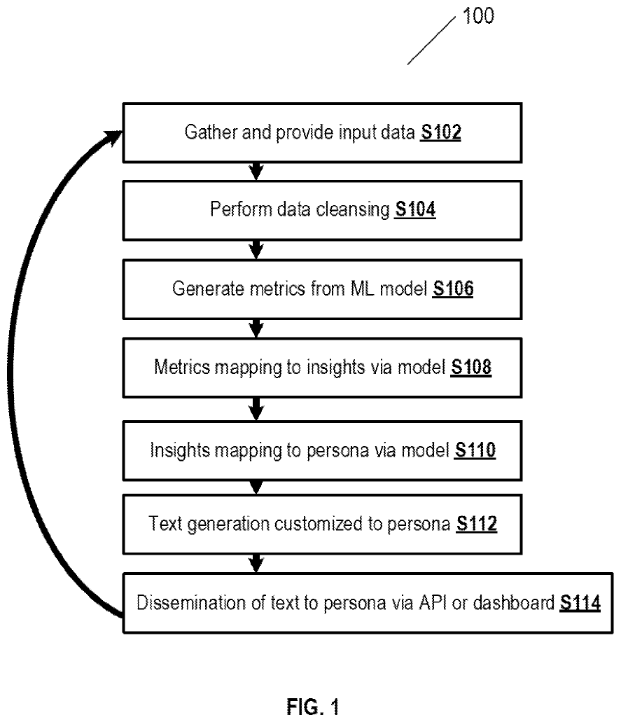

FIG. 1 illustrates an example process flow 100 for generating persona-based insights, in accordance with an example implementation. The process begins at step S102, where data is gathered and received from an IoT system. Sensor data may include, but not limited to, sensor data, control logs, historical maintenance data, etc. At step S104, data cleansing is performed to remove defects from the gathered/received data to generate cleansed data.

At step S106, the cleansed data are fed as input into a machine learning model for processing and machine learning metrics are generated as output from the machine learning model. Generated machine learning metrics may include, but not limited to, probability of failure, categorical classification, risk score, etc.

At step S108, an insights model ingests the machine learning metrics to produce insights data such as root cause of failure, suggested action, etc. At step S110, a persona model takes the insights data as input to generate a list of personas/personas data. The personas data may have characteristics that include, but not limited to role, experience, technical knowledge, asset expertise, etc.

At step S112, the insights data and the personas data, are sent to a persona-based text generation model to provide custom insights for the respective personas of the personas data. The process then proceeds to step S114, where the custom insights are disseminated to the personas via an interface such as a dashboard or application programming interface (API).

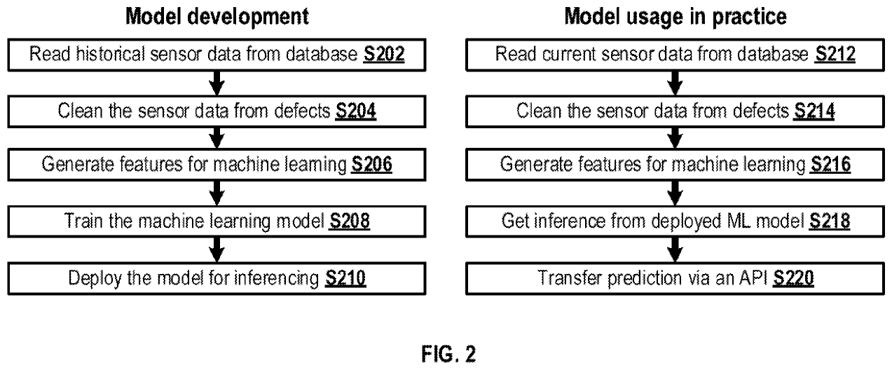

FIG. 2 illustrates example process flows for machine learning model development and deployment/actual use, in accordance with an example implementation. Under model development, the process begins at step S202, where historical sensor data is read from a database. At step S204, the sensor data is cleaned to remove defects. At step S206, training features are generated based on the cleansed historical sensor data. At step S208, the machine learning model is generated based on the training features and training the machine learning model using the historical sensor data. The development process then proceeds to step S210, where the trained machine learning model is deployed for inferencing.

As illustrated in FIG. 2, under actual use, the process flow begins at step S212, where current sensor data is received from the database or directly from the sensor(s). At step S214, the sensor data is cleaned to remove defects. At step S216, features are generated based on the cleansed sensor data. At step S218, the machine learning metrics are generated based on inferencing from the deployed machine learning model with the generated features. The machine learning metrics may include information such as, but not limited to, probability of failure, probability density vector, anomaly score, local outlier factor, etc. In some example implementations, a class of machine learning algorithms produces prominent contribution factors or features leading to calculation of above metrics. The actual use process then proceeds to step S220, where the generated machine learning metrics are transferred via an API.

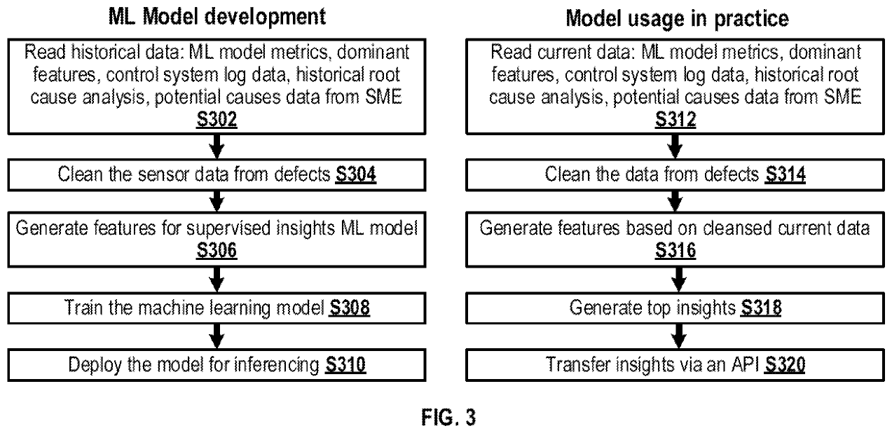

FIG. 3 illustrates example process flows for model development and deployment/actual use of the insights model, in accordance with an example implementation. Under model development, the process begins at step S302, where historical data is retrieved/read from the database. Historical data may include past information such as, but not limited to, machine learning metrics, features data, control system log data, historical root cause analysis, historical insights, rules from subject matter experts (SME), failure modes and effects analysis (FMEA), potential causes data from SME, etc. At step S304, the historical data is cleaned to remove defects. At step S306, training features are generated based on the cleansed historical data. At step S308, an insights model is generated based on the training features and training the insights model using the historical data. The insights model may use explainable artificial intelligence (AI) for solution resolution and utilize physics to generate explainability. The development process then proceeds to step S310, where the trained insights model is deployed for inferencing.

As illustrated in FIG. 3, under actual use, the process flow begins at step S312, where current data is retrieved/read. Current data may include information such as, but not limited to, machine learning metrics, features data, control system log data, historical root cause analysis, historical insights, rules from subject matter experts (SME), failure modes and effects analysis (FMEA), potential causes data from SME, etc. Machine learning metrics, features data, and control system log data can be grouped as X data, while historical root cause analysis, historical insights, rules from SME, FMEA, and potential causes data from SME can be grouped as Y data.

At step S314, the current data is cleaned to remove defects. At step S316, features are generated based on the cleansed current data. At step S318, insights data are generated based on inferencing from the deployed insights model with the generated features. The actual use process then proceeds to step S320, where the generated insights data are transferred via an API. In some example implementations, the insights model is a rule-based algorithm as opposed to an ML model.

The generated insights data may be worth examining by personas of different expertise/disciplinary fields. For example, a high temperature anomaly in a large motor may be examined by a mechanical engineer for potential bearing failure as result of frictional heating. At the same time, the same temperature anomaly may need to be examined by an electrical engineer for potential electrical wiring issues in the motor.

The insights data can be mapped to different personas through a personas model. In some example implementations, the personas model is an expert system model or a rule-based engine/algorithm. The expert system model is applied in the design of a new system where historical operational data is not readily available or where quality data is severely lacking to build a reliable data driven model. The expert system model may be based on information such as, but not limited to, operational manuals, maintenance manual, user manuals, SME knowledge, best practices, etc. In alternate example implementations, wherein historical operational data is readily available and insights are associated with different personas, a machine learning model (e.g., collaboration filter, etc.) can be utilized in developing the personas model.

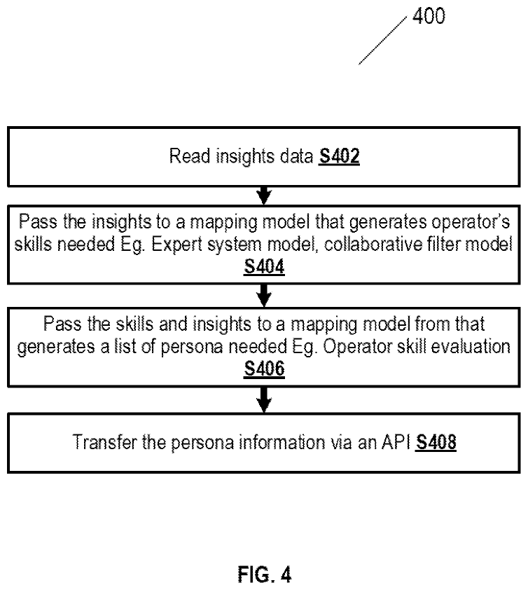

FIG. 4 illustrates example process flow 400 for persona generation through a personas model, in accordance with an example implementation. The personas model performs the functions of identifying required operator's skill sets and generating personas data/attributes that identifies personas possessing the identified required operator's skill sets. Operator's skill sets may include information such as, but not limited to, a vector of disciplines, level of expertise, asset specific expertise, etc. On the other hand, personas data/attributes may include information such as, but not limited to, roles, responsibility, expertise, assets worked on, and etc., of personas that can assist in troubleshooting and repairing devices as having issues based on the insights data. In some example implementations, the personas model may comprise two components, a skill generator/skill mapping model and a persona generator/persona mapping model. The skill generator performs the function of identification of required operator's skill sets, while the persona generator performs the function of personas data generation.

The process flow begins at step S402, where insights data is retrieved/read. At step S404, the insights data is passed to the skill mapping model to generate required operator's skill sets. At step S406, the generated required operator's skill sets and the insights data are passed to the personas mapping model to generate the personas data. In some example implementations, the personas data is in the form of vectors. The process then proceeds to step S408, where the personas data is transferred via an API.

Once the insights data is generated, the insights data is translated to persona-specific language through transformer models/language models. In some example implementations, the transformer models/language models are deep learning-based transformer algorithms. The transformer models/language models are used for performing text translation and translation customization, e.g., through associated encoder and decoder architectures. Text-based summaries are generated as output from the transformer models/language models for identified/specified personas. For example, customized texts can be generated for mechanical engineer, electrical engineer, etc., through different transformer models/language models, where each transformer model/language model performs translation for a different persona. In some example implementations, audio or video summaries may be provided instead of text-based summaries.

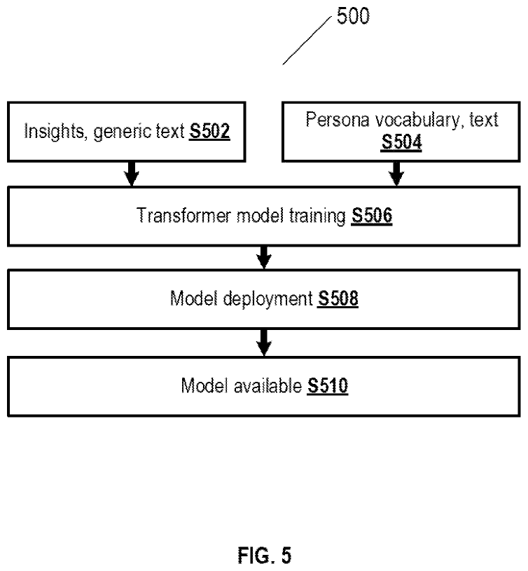

FIG. 5 illustrates an example process flow 500 for transformer model/text generation model/language model development and deployment, in accordance with an example implementation. At step S502, historical insights are used as input feature data. At step S504, persona-based vocabulary is provided as input in generating persona-specific text. Persona-based vocabulary may include terminology and definitions uniquely associated with personas of different fields of discipline.

At step S506, the transformer model/text generation model/language model is trained using the historical insights and persona-based vocabulary. The transformer model/text generation model/language model is trained by performing correlation identification between associate insights and persona-based vocabulary to systematically generate customized/personalized texts catered to the respective identified personas. The taxonomy complexity across disciplines for explaining the same set of digital signals/data need to be encapsulated within the intelligence system with proper interpretations of the same term.

In some example implementations, multiple transformer models/language models may be developed for each persona. In some example implementations, Generative Pre-trained Transformer 3 (GPT3), an autoregressive language model, may be utilized in the development of the transformer models/language models. At step S508, the trained models are deployed for future use. At step S510, the trained models are made available/transferred via an API.

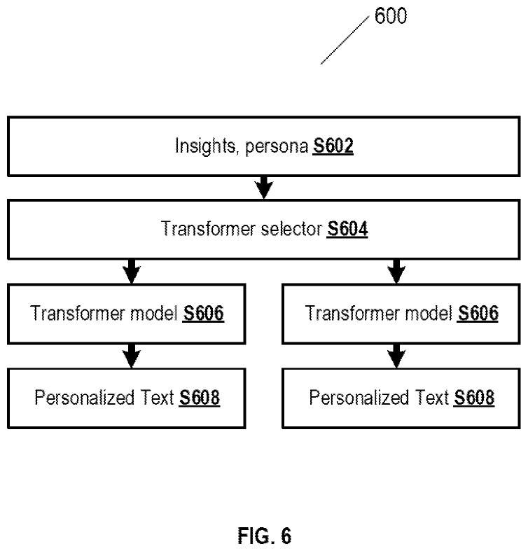

FIG. 6 illustrates an example process flow 600 for generating personalized text through transformer models/language models, in accordance with an example implementation. At step S602, the insights data and the personas data are retrieved/read from the personas model. At step S604, the retrieved/read data are provided as input to a transformer selector. The transformer selector, depending on personas of the personas data, matches and selects one or more transformer models/language models, at step S606. At step S608, each of the transformer models/language models generates customized/personalized text for the respective persona. The generated customized/personalized texts are then sent through an interface such as an API to the personas for consumption/review.

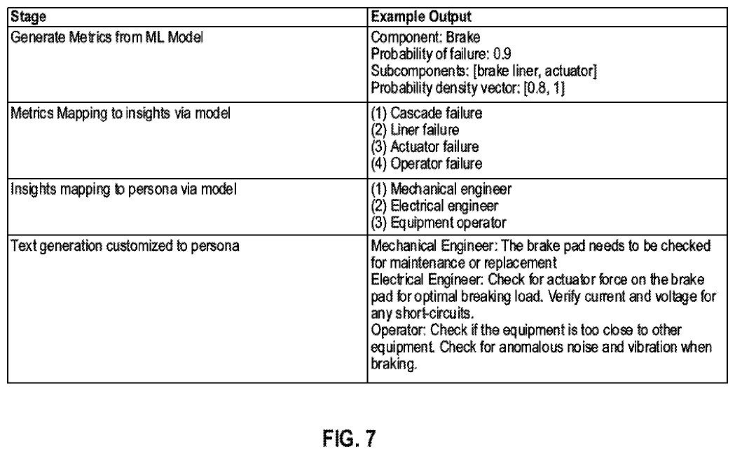

FIG. 7 illustrates example outputs from the various models, in accordance with an example implementation. Metrics are generated from the ML model through performance of feature engineering from input data. FIG. 7 illustrates an example output from the ML model, which identifies brake as the component at issue, with a probability of failure of 0.9. In addition, sub-components such as brake liner and actuator are identified, and a probability density vector is output. The insights model then uses the metrics to derive insights to the input. FIG. 7 illustrates an example output from the insights model, which identifies the potential issues at hand. Specifically, failures associated with cascade, liner, actuator, and operator.

The personas model generates personas data that identifies personas possessing the unique skill sets through insight mapping. As illustrated in FIG. 7, the personas model generates machinal engineer, electrical engineer, and equipment operator as output based on the provided insights. Lastly, the transformer models/language models generate the customized/personalized text for the respective persona. For example, the mechanical engineer may receive the custom text “The brake pad needs to be checked for maintenance or replacement,” the electrical engineer may receive the custom text “Check for actuator force on the brake pad for optimal breaking load. Verify current and voltage for any short-circuits”, the equipment operator may receive the custom text “Check if the equipment is too close to other equipment. Check for anomalous noise and vibration when braking,” etc.

The foregoing example implementation may have various benefits and advantages. For example, provision of segregated and customized insights/texts to respective persona to allow efficient troubleshooting and upkeep. Customized texts based on persona-specific vocabulary and disciplinary fields allow for targeted message delivery in technical language understood by the respective recipient.

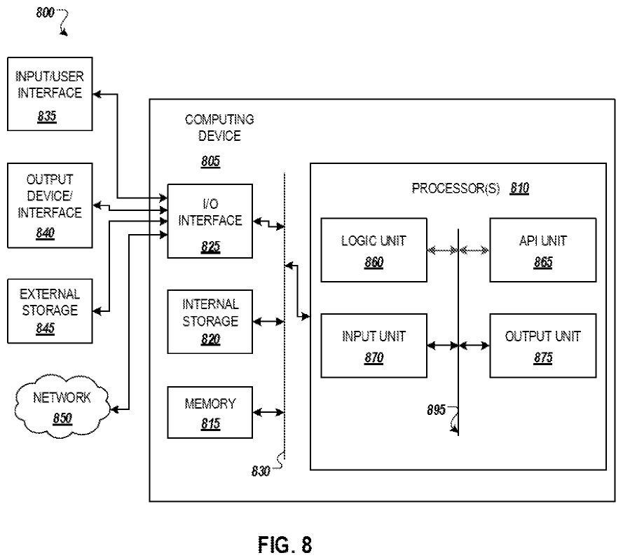

FIG. 8 illustrates an example computing environment with an example computing device suitable for use in some example implementations. Computing device 805 in computing environment 800 can include one or more processing units, cores, or processor(s) 810, memory 815 (e.g., RAM, ROM, and/or the like), internal storage 820 (e.g., magnetic, optical, solid-state storage, and/or organic), and/or I/O interface 825, any of which can be coupled on a communication mechanism or bus 830 for communicating information or embedded in the computing device 805. I/O interface 825 is also configured to receive images from cameras or provide images to projectors or displays, depending on the desired implementation.

Computing device 805 can be communicatively coupled to input/user interface 835 and output device/interface 840. Either one or both of the input/user interface 835 and output device/interface 840 can be a wired or wireless interface and can be detachable. Input/user interface 835 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 840 may include a display, television, monitor, printer, speaker, braille, or the like. In some example implementations, input/user interface 835 and output device/interface 840 can be embedded with or physically coupled to the computing device 805. In other example implementations, other computing devices may function as or provide the functions of input/user interface 835 and output device/interface 840 for a computing device 805.

Examples of computing device 805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 805 can be communicatively coupled (e.g., via I/O interface 825) to external storage 845 and network 850 for communicating with any number of networked components, devices, and systems, including one or more computing devices of the same or different configuration. Computing device 805 or any connected computing device can be functioning as, providing services of, or referred to as, a server, client, thin server, general machine, special-purpose machine, or another label.

I/O interface 825 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, satellite network, and the like).

Computing device 805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computing device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 810 can execute under any operating system (OS) (not shown), in a native or virtual environment. One or more applications can be deployed that include logic unit 860, application programming interface (API) unit 865, input unit 870, output unit 875, and inter-unit communication mechanism 895 for the different units to communicate with each other, with the OS, and with other applications (not shown). The described units and elements can be varied in design, function, configuration, or implementation and are not limited to the descriptions provided. Processor(s) 810 can be in the form of hardware processors such as central processing units (CPUs) or in a combination of hardware and software units.

In some example implementations, when information or an execution instruction is received by API unit 865, it may be communicated to one or more other units (e.g., logic unit 860, input unit 870, output unit 875). In some instances, logic unit 860 may be configured to control the information flow among the units and direct the services provided by API unit 865, the input unit 870, and the output unit 875 in some example implementations described above. For example, the flow of one or more processes or implementations may be controlled by logic unit 860 alone or in conjunction with API unit 865. The input unit 870 may be configured to obtain input for the calculations described in the example implementations, and the output unit 875 may be configured to provide an output based on the calculations described in example implementations.

Processor(s) 810 can be configured to receive sensor data associated with a device as illustrated in FIG. 1. The processor(s) 810 may also be configured to clean the received sensor data to generate cleansed data as illustrated in FIG. 1. The processor(s) 810 may also be configured to process using a machine learning model to generate machine learning metrics as illustrated in FIG. 1. The processor(s) 810 may also be configured to ingest the machine learning metrics to generate insights data associated with the device as illustrated in FIG. 1. The processor(s) 810 may also be configured to generate personas data using the insights data, and mapping the insights to the personas data as illustrated in FIG. 1. The processor(s) 810 may also be configured to generate custom insights using the insights data and the personas data, wherein the custom insights are text-based summaries as illustrated in FIG. 1. The processor(s) 810 may also be configured to disseminate each of the custom insights to respective persona of the personas data to place service orders associated with the device as illustrated in FIG. 1.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to, optical disks, magnetic disks, read-only memories, random access memories, solid-state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored in the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for generating persona specific insights, the method comprising:
receiving sensor data associated with a device;
cleaning the received sensor data to generate cleansed data;
processing the cleansed data using a machine learning model to generate machine learning metrics;
ingesting the machine learning metrics to generate insights data associated with the device;
generating personas data using the insights data, and mapping the insights to the personas data;
generating custom insights using the insights data and the personas data, wherein the custom insights are text-based summaries; and
disseminating each of the custom insights to respective persona of the personas data to place service orders associated with the device.

2. The method of claim 1, wherein the custom insights are disseminated through at least one of dashboard or an application programming interface (API).

3. The method of claim 1, wherein the machine learning metrics comprise at least one of probability of failure, probability density vector, anomaly score, or local outlier factor.

4. The method of claim 1, wherein the machine learning model is derived by:
retrieving historical sensor data form a database;
cleaning the historical sensor data from defects;
generating training features based on the cleaned historical sensor data;
generating the machine learning model based on the training features and training the machine learning model using the historical sensor data; and
deploying the trained machine learning model.

5. The method of claim 1, wherein the ingesting the machine learning metrics to generate the insights data associated with the device comprises:
receiving input data comprising the sensor data, the machine learning metrics, and potential causes data to an insights model; and
generating the insights data as output from the insights model.

6. The method of claim 5, wherein the insights model comprises one of a machine learning model or a rule-based algorithm.

7. The method of claim 1, wherein the generating personas data using the insights data comprises:
processing the insights data over a skill mapping model to generate required operator's skill sets; and
processing the insights data and the required operator's skill sets over a persona mapping model to generate the personas data,
wherein the personas data is a list of personas that possess the required operator's skill sets.

8. The method of claim 7, wherein the personas data is a list of personas that possess the required operator's skill sets.

9. The method of claim 1, wherein the generating the custom insights using the insights data and the personas data comprises:
receiving the insights data and the personas data as input to a transformer selector to perform language model selection from a plurality of language models by matching each persona of the personas data with at least one language model of the plurality of language models; and
generating at least one custom insight derived from each transformers model being matched to each persona of the personas data.

10. The method of claim 9, wherein the plurality of language models is derived by:
using historical insights data and persona vocabulary as input to train the plurality of language models, wherein persona vocabulary comprises terminology and definitions uniquely associated with personas of different fields of discipline, and training of the plurality of language models is performed by performing correlation identification between historical insights data and persona vocabulary; and
deploying the trained plurality of language models.

11. A non-transitory computer readable medium, storing instructions for generating persona specific insights, the instructions comprising:
receiving sensor data associated with a device;
cleaning the received sensor data to generate cleansed data;
processing the cleansed data using a machine learning model to generate machine learning metrics;
ingesting the machine learning metrics to generate insights data associated with the device;
generating personas data using the insights data, and mapping the insights to the personas data;
generating custom insights using the insights data and the personas data, wherein the custom insights are text-based summaries; and
disseminating each of the custom insights to respective persona of the personas data to place service orders associated with the device.

12. The non-transitory computer readable medium of claim 11, wherein the custom insights are disseminated through at least one of dashboard or an application programming interface (API).

13. The non-transitory computer readable medium of claim 11, wherein the machine learning metrics comprise at least one of probability of failure, probability density vector, anomaly score, or local outlier factor.

14. The non-transitory computer readable medium of claim 11, wherein the machine learning model is derived by:
retrieving historical sensor data form a database;
cleaning the historical sensor data from defects;
generating training features based on the cleaned historical sensor data;
generating the machine learning model based on the training features and training the machine learning model using the historical sensor data; and
deploying the trained machine learning model.

15. The non-transitory computer readable medium of claim 11, wherein the ingesting the machine learning metrics to generate the insights data associated with the device comprises:
receiving input data comprising the sensor data, the machine learning metrics, and potential causes data to an insights model; and
generating the insights data as output from the insights model.

16. The non-transitory computer readable medium of claim 15, wherein the insights model comprises one of a machine learning model or a rule-based algorithm.

17. The non-transitory computer readable medium of claim 11, wherein the generating personas data using the insights data comprises:
processing the insights data over a skill mapping model to generate required operator's skill sets; and
processing the insights data and the required operator's skill sets over a persona mapping model to generate the personas data,
wherein the personas data is a list of personas that possess the required operator's skill sets.

18. The non-transitory computer readable medium of claim 17, wherein the personas data is a list of personas that possess the required operator's skill sets.

19. The non-transitory computer readable medium of claim 11, wherein the generating the custom insights using the insights data and the personas data comprises:
receiving the insights data and the personas data as input to a transformer selector to perform language model selection from a plurality of language models by matching each persona of the personas data with at least one language model of the plurality of language models; and
generating at least one custom insight derived from each transformers model being matched to each persona of the personas data.

20. The non-transitory computer readable medium of claim 19, wherein the plurality of language models is derived by:
using historical insights data and persona vocabulary as input to train the plurality of language models, wherein persona vocabulary comprises terminology and definitions uniquely associated with personas of different fields of discipline, and training of the plurality of language models is performed by performing correlation identification between historical insights data and persona vocabulary; and
deploying the trained plurality of language models.
